(19) United States
(12) Patent Application Publication
(10) Pub. No.: US 2022/0318789 A1
(43) Pub. Date: Oct. 6, 2022

(54) Method and System for Anonymous Payments Online

(71) Applicant: Rafal Marek Leszczyna, Gdansk (PL)

(72) Inventor: Rafal Marek Leszczyna, Gdansk (PL)

(21) Appl. No.: 17/842,818

(22) Filed: Jun. 17, 2022

(51) Int. Cl. G06Q 20/38; G06Q 30/02; G06Q 20/12

(52) U.S. Cl. CPC G06Q 20/383; G06Q 30/0222; G06Q 20/12

(57) ABSTRACT

The present invention relates to a method and a system that enable a person to anonymously pay for a product or a service. The payment is realized by accessing by the payer a website or a web service accessing which is rewarded by the owner of the website or web service. Alternatively, the payment is realized by accessing a website or web service and performing specific activities rewarded by the owner of the website. No payer's personal data are retained in the system.

### FIELD OF THE INVENTION

The present invention relates to the field of electronic communications and particularly to a method and a system that enable a person to anonymously pay for a product or a service.

### BACKGROUND OF THE INVENTION

Multiple contexts exist in which a party wishes to anonymously pay for a product or a service. In anonymous e-health counseling, patients request for and obtain medical treatment-related guidance. The patients would like to remain anonymous not only during the interactions with a physician but also during other connected activities, including payment. Otherwise, the identity of the patient could be discovered from the other activities. The same problem may concern other endeavors, including remote shopping, paid e-mail, web publishing, online auctioning, and other online services. This also applies to non-digital activities such as traditional shopping, publishing, mailing, or voting. In all the endeavors one might prefer to retain their payments anonymous.

A common approach to anonymous payments is based on the introduction into the payment process of intermediate parties (proxies) that hide the payer data from the payee. However, to effectuate the payment and assure a real cash flow, the payer data need to be provided to financial institutions for which they are stored at the proxy. As a result, anonymity can be revoked at any moment. The proxy systems comprise anonymizers, anonymity services, interconnected anonymous and non-anonymous user profiles, transaction servers, central payment agents, financial institutions, clearing houses, and others.

Anonymous accounts or virtual accounts are bank accounts where user personal data are hidden from a payee. They can be an effective means of anonymous payment if for their opening no personal data is required. However, in many countries national regulations require financial institutions to be aware of the identity of account holders which prohibits opening anonymous bank accounts.

Anonymous virtual credit or debit cards are credit or debit cards issued by financial institutions such as banks where user personal data are obfuscated. If the cards could be obtained from a financial institution without providing any personal information, effective anonymity of payments could be achieved. However, similarly to anonymous accounts, in many countries, national regulations prohibit issuing of anonymous payment cards.

Similarly, prepaid cards, gift cards, or vouchers can provide anonymity of payments. Prepaid cards are, usually plastic, credit card-sized, cards that can be exchanged for a specified cash value of goods or services from a particular business. The cards can contain a chip that provides additional features, including security functions. Gift cards can be perceived as a variation of prepaid cards, where the cards are intended to be handed over to another person as a gift. Also, digital wallets can be interpreted as a form of a prepaid card, where the card functions are provided by a computer program. The program can be then stored on various media or devices such as smartphones, tablets, personal computers, or dedicated computer architectures, including handheld or wearable devices. In vouchers, a small printed piece of paper is used in place of the card. These solutions exhibit a large anonymity potential, especially when acquired or charged by cash at a retailer location. However, their application is limited to a specified group of payees that recognize and accept them as means of payment.

In this context, electronic cash or e-cash appears to be a promising solution. Electronic cash or e-cash is an electronic equivalent of physical cash. It replicates all the transactional features of the physical cash, including the value assured by a financial institution as well as anonymity and privacy-respecting features. However, currently, the introduction of the e-cash is in the preliminary stages.

### SUMMARY OF THE INVENTION

The present invention relates to a method and a system that address the disadvantages of the solutions described above and other disadvantages not described above or constitutes an alternative instrument to perform anonymous payments.

The subject matter claimed herein is not limited to embodiments that solve the above disadvantages or that operate only in environments such as those described above. Rather, this background is only provided to illustrate selected application areas where some embodiments described herein may be practiced.

### BRIEF DESCRIPTION OF DRAWINGS

Embodiments of the disclosure may be better understood by referencing the accompanying drawings.

FIG. 1 is a block diagram depicting the components of the system of the invention according to one embodiment.

FIG. 2 illustrates an embodiment of the method of the invention.

It should be understood that the present drawings are not necessarily to scale and that the embodiments disclosed herein are sometimes illustrated by fragmentary views. In certain instances, details that are not necessary for an understanding of the present invention or which render other details difficult to perceive may have been omitted. Instead, the emphasis is being placed on illustrating the principles of the invention. It should also be understood that the invention is not necessarily limited to the particular embodiments illustrated herein. Like numbers utilized throughout the various figures designate like or similar parts or structure.

### DETAILED DESCRIPTION OF THE INVENTION

In the following description, specific details of the present invention are provided. Various modifications to the disclosed embodiments will be readily apparent to those skilled in the art, and the general principles defined herein may be applied to other embodiments and applications without departing from the spirit and scope of the present invention. At the same time, well-known features have not been described in detail so as not to obscure the invention. Thus, the present invention is not intended to be limited to the embodiments presented but is to be accorded the widest scope consistent with the principles and features disclosed herein.

The invention relates to a method and a system that enable a person to anonymously pay for a product or a service.

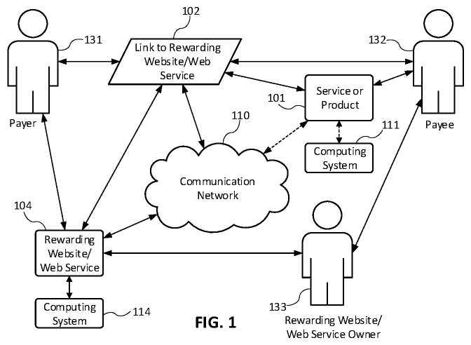

FIG. 1 illustrates an embodiment of the system of the invention.

The system comprises one or multiple webpages or web services 104 accessing which or accessing which and performing specific activities is rewarded by the owner of the webpage or web service 133 to the party that included a link to the webpage or web service in their service or product. For the clarity of the description, each such website or web service may be referred to as a rewarding webpage/web service 104. According to the present invention, accessing one or multiple rewarding webpages/web services, or accessing one or multiple webpages/web services and performing specific activities may be performed by one or multiple payers 131.

In one embodiment, rewarding the party that included a link to a website or web service in their service or product can be performed by paying. In another embodiment, rewarding can be performed by providing products or services in exchange for including a link to the website or web service in a service or product.

Multiple embodiments of rewarding websites/web services are known to those skilled in the art. As one embodiment, after a link is followed to redirect a user from an initial digital content that contains a link to a rewarding website/web service, an identifier of the initial digital content is sent to the rewarding website/web service. The rewarding website/web service can later connect the identifier to a legal entity to reward it for including the link in its digital content. As another embodiment, the link can have a specific form (a specific address) for each different legal entity that includes it in their digital or non-digital product or service. Consequently, an owner of the rewarding website/web service can recognize and reward the legal entity based on the specific address through which it was accessed.

As yet another embodiment, performing specific activities when accessing a rewarding website/web service is rewarded. For instance, performing specific activities can be watching one or multiple advertisements present on a website. As another example, a specific activity may be performing one or more computations using the computing resources of a website visitor in relation to the contents present on the website. As yet another example, a specific activity may be performing one or more computations using the computing resources of a web service's user according to the logic of the web service. In one embodiment the website may comprise executable code that may be run on the page visitor's computing device as a specific activity. As yet another example, a specific activity may be solving one or multiple problems specified in the rewarding website. In one embodiment the problem may refer to a specific decision situation where the solution is providing an appropriate decision. In another embodiment, the problem may be a mathematical problem, such as solving an equation or proving a theorem. Also, performing a specific activity may be responding to a survey, for instance by filling in a questionnaire present on a website.

As another example, performing a specific activity may be recommending or reviewing one or multiple products or services. As yet another example, performing a specific activity may be playing a character or operating a virtual entity, such as an avatar, working in cyberspace, or operating a virtual infrastructure, such as a virtual city or neighborhood, etc. in a game or similar virtual arrangement. Also, performing a specific activity may be downloading data, including digital products from a website or web service, or uploading data, including digital products to a website or web service. Some examples of digital products include electronic documents, e-books, downloadable music, photos, digital videos and graphics, computer applications, computer games, source code, websites, virtual goods used within the virtual economies of online games and communities, and e-learning materials or video tutorials. As another example, performing a specific activity may be uploading to a website or web service a digital certificate or a digital item acquired by cash.

The system of the invention comprises also one or multiple services 101 or products 101 provided by a payee 132. Each service or product may have a non-digital or digital form. The former may be referred to as a non-digital service or product, the latter may be referred to as a digital service or product. Digital services or products may require for their operation one or multiple computing systems 111.

Examples of services in a non-digital form include publishing, mailing, auctioning, voting, or health counseling. Publishing refers to making information, literature, music, software, and other usually printed content available to a set of recipients. Mailing services enable the physical transfer of items such as letters, postcards, and parcels between geographical locations. Auctioning services facilitate the organization of public sales where participants can buy goods or services by bidding. Voting services support the formal expression of preference for a candidate for office or for a proposed resolution of an issue. Health counseling services provide individuals with medical, pharmaceutical, and dietary knowledge related to the individuals' health situation.

The corresponding services in a digital form are web publishing, e-mail, online auctioning, electronic voting, and e-health counseling. Web publishing refers to delivering information content on the Internet. Among the others, it is associated with creating, maintaining, and updating websites. The information content may include text, videos, sound, digital images, artwork, and other forms of media. E-mail services facilitate sending and receiving messages electronically over a communication network. Online auctioning enables acquiring property or items of merchandise by the highest bidder using electronic media, including communication networks and information systems. Electronic voting is a form of information technology-mediated voting in which voters express their preferences with the aid of a computing system. E-health counseling embraces all functionalities and activities necessary to provide an individual with comprehensive medical, pharmaceutical, and dietary knowledge related to the individual's health situation using electronic means. For all the above-described sample services anonymity of the service's recipient is a significant enabler.

Products in a non-digital form include durable goods such as houses, cars, furniture, and computers and non-durable goods such as food and beverages. Products that have a digital form are commonly named digital products. They are represented as strings of discrete symbols belonging to a finite set. The most common set of symbols used for the representation of digital products is a binary set. It comprises two symbols corresponding to two values typically represented as either 1 or 0. Examples of digital products include electronic documents, e-books, downloadable music, internet radio, internet television and streaming media, website contents and themes, blog posts, fonts, logos, photos, digital videos and graphics, digital subscriptions, online advertisements, electronic tickets, computer applications, computer games, source code, websites, virtual goods used within the virtual economies of online games and communities, e-learning materials or video tutorials.

Each of the services 101 or products 101 may comprise one or multiple links 102 to one or multiple rewarding websites/web services 104 accessing which or accessing which and performing specific activities is rewarded by the owner of the website or web service 133 to the party that included the link or links in their service or product. For the clarity of the description, an owner of a website or web service may be referred to as a rewarding website/web service owner 133. Each rewarding website/web service 104 is stored, processed and run in one or multiple computing systems 114.

As one embodiment, the link may have a form of a text link with an address of a website or web service accessing which or accessing which and performing specific activities is rewarded by the owner of the website or web service. For instance, it can be written, painted, printed, or visualized in another way on any non-digital document associated with a non-digital or digital service, such as a publisher's advertisement or published materials for a publishing or web publishing service, an envelope, or postcard for mailing service, a printed advertisement of an e-mail service, an auction leaflet or online auctioning advertisement for auctioning services, voting announcement for voting or e-voting service or health counseling information or physician's data for a health counseling or e-health counseling service. As another example, the text link can be included in any digital content associated with a digital or non-digital service. It can be introduced into electronic documents, e-books, internet television, and streaming media, website contents and themes, blog posts, logos, photos, digital videos and graphics, digital subscriptions, online advertisements, electronic tickets, computer applications, computer games, websites, virtual goods used within the virtual economies of online games and communities, e-learning materials or video tutorials.

As yet another example, the text link can be written, painted, printed, or visualized in another way on a non-digital product such as a house, a car, or furniture. As far as digital products are concerned, the text link can be included in electronic documents, e-books, internet television, and streaming media, website contents and themes, blog posts, logos, photos, digital videos and graphics, digital subscriptions, online advertisements, electronic tickets, computer applications, computer games, websites, virtual goods used within the virtual economies of online games and communities, e-learning materials or video tutorials.

In addition, the system of the invention comprises a communication network 110. The communication network may have an electronic form. In such an embodiment, the network can include any type of wired or wireless communication channel capable of linking computing nodes. This includes, but is not limited to, a local area network, a wide area network, or a combination of networks. In particular, the Internet may be utilized as a communication network. The communication network constitutes an intermediary medium that allows a user to access a rewarding website/web service.

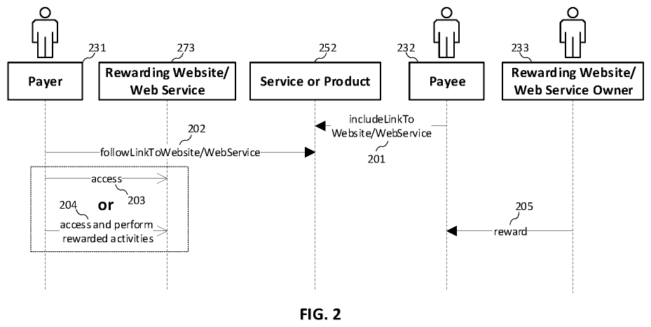

FIG. 2 presents an embodiment of the method of the invention. In the embodiment, a payee 232 includes 201 in a payee's service or a payee's product 252 one or multiple links to one or multiple websites or web services (rewarding websites/web services) 273 accessing which or accessing which and performing specific activities is rewarded by the owner of the website or web service (rewarding website/web service owner) to the party that included the link in their service or product.

In one embodiment, including the link 201 may be performed by writing, painting, printing, or visualizing in another way on any non-digital document associated with a non-digital or digital service, a text link with an address of a website or web service of which accessing or accessing which and performing specific activities is rewarded by the owner of the website or web service. In another embodiment, including the link 201 may be performed by writing, painting, printing, or visualizing in another way on a non-digital product such as a house, a car, or furniture, a text link with an address of a website or web service of which or accessing which and performing specific activities is rewarded by the owner of the website or web service. In yet another embodiment, including the link 201 may be performed by introducing the link into any digital content associated with a digital or non-digital service. Also, including the link 201 may be performed by introducing the link directly into a digital product.

One or multiple payers 231 may follow 202 one or a multiplicity of the links. In one embodiment, when a link has a form of a text link with an address of a website and is written, painted, printed, or visualized in another way on any non-digital document associated with a non-digital or digital service, following the link may be performed by retyping the address into a web browser on a computing device connected to a communication network and confirming the address to cause the web browser to open the website. Similarly, in another embodiment, when a link has a form of a text link with an address of a website and is written, painted, printed, or visualized in another way on a non-digital product such as a house, a car, or furniture, following the link may be performed by retyping the address into a web browser on a computing device connected to a communication network and confirming the address to cause the web browser to open the website. As another example, when a link has a form of a text link with an address of a web service and is written, painted, printed, or visualized in another way on a non-digital product such as a house, a car, or furniture, following the link may be performed by retyping the address into an application running on a computing device connected to a communication network and confirming the address to cause the application to access the web service. In yet another embodiment, when a link to a website or web service is included in a digital product or a digital content associated with a digital or non-digital service, following the link may be performed by clicking on a representation of the link such as a text or an image to cause a web browser to open the website or to cause a web service's client application to access the web service.

Depending on a particular embodiment of the system of the invention, already accessing a website or web service 273 by the one or multiple payers 231 may be rewarded by a rewarding website/web service owner 233. In another embodiment, for the payee 232 to be rewarded 205 by a rewarding website/web service owner 233, the one or multiple payers 231 will need to access a website or web service 273 and perform specific activities that are rewarded by the owner of the website or web service 233.

One or multiple payers 231 may access a website or web service 203 or may access a website or service 273 and perform specific activities 204 that are rewarded by the owner of the website or web service 233. In reaction to that, the owner of the website or web service 233 rewards 205 the payee for accessing a linked website or web service by the payer or accessing a linked website or web service and performing the rewarded activities by the payer.

Various modifications could be made to the exemplary embodiments, as described above concerning the corresponding illustrations. Thus, without departing from the scope of the invention, it is intended that all matter contained in the foregoing description and shown in the accompanying drawings shall be interpreted as illustrative rather than limiting. The breadth and scope of the present invention should not be limited by any of the above-described exemplary embodiments but should be defined only in accordance with the following claims appended hereto and their equivalents. It will be understood that the above-described arrangements of the system and the method therefrom are merely illustrative of applications of the principles of this invention and many other embodiments and modifications may be made without departing from the spirit and scope of the invention as defined in the claims.

What is claimed:

1. A method that enables online payment in an anonymous way, the method comprising:
including by a payee in a payee's service or a payee's product at least one link to a website or web service accessing which or accessing which and performing specific activities is rewarded by the owner of the website or web service to the party that included the link in their service or product,
following by at least one payer at least one of the links and accessing by the payer a linked website or web service, or accessing by the payer a linked website or web service, and performing the activities that are rewarded by the owner of the website or web service,
rewarding the payee for accessing by the payer a linked website or web service, or accessing by the payer a linked website or web service and performing the rewarded activities by the owner of the website or web service.

2. The method of claim 1, wherein rewarding is performed by paying.

3. The method of claim 1, wherein performing specific activities is watching at least one advertisement.

4. The method of claim 1, wherein performing specific activities is performing at least one computation.

5. The method of claim 1, wherein performing specific activities is solving at least one problem provided.

6. The method of claim 1, wherein performing specific activities is responding to a survey.

7. The method of claim 1, wherein performing specific activities is recommending or reviewing at least one product or service.

8. The method of claim 1, wherein performing specific activities is operating a virtual entity or playing a character in a virtual arrangement.

9. The method of claim 1, wherein performing specific activities is downloading or uploading data.

10. The method of claim 1, wherein performing specific activities is uploading a digital certificate or an item acquired by cash.

11. A system that enables online payment in an anonymous way, the system comprising:
at least one payee's service or at least one payee's product,
at least one link to a website or web service accessing which or accessing which and performing specific activities is rewarded by the owner of the website or web service to the party that included the link in their service or product,
at least one website or web service accessing which or accessing which and performing specific activities is rewarded by the owner of the website or web service to the party that included a link to the website or web service in their service or product,
a communication network,
the system enabling to perform a method comprising:
including by a payee in the payee's service or the payee's product at least one link to a website or web service accessing which or accessing which and performing specific activities is rewarded by the owner of the website or web service to the party that included the link in their service or product,
following the at least one link by at least one payer and accessing a linked website or web service or accessing a linked website or web service and performing the activities that are rewarded by the owner of the website or web service, rewarding the payee by the owner of the website or web service for accessing by the payer a linked website or web service or accessing by the payer a linked website or web service and performing the rewarded activities.

12. The system of claim 11 wherein rewarding is performed by paying.

13. The system of claim 11, wherein performing specific activities is watching at least one advertisement.

14. The system of claim 11, wherein performing specific activities is performing at least one computation.

15. The system of claim 11, wherein performing specific activities is solving at least one problem provided.

16. The system of claim 11, wherein performing specific activities is responding to a survey.

17. The system of claim 11, wherein performing specific activities is recommending or reviewing at least one product or service.

18. The system of claim 11, wherein performing specific activities is operating a virtual entity or playing a character in a virtual arrangement.

19. The system of claim 11, wherein performing specific activities is downloading or uploading data.

20. The system of claim 11, wherein performing specific activities is uploading a digital certificate or an item acquired by cash.
